(19) United States
(12) Patent Application Publication
(10) Pub. No.: US 2008/0156361 A1
(43) Pub. Date: Jul. 3, 2008

(54) SUBSTRATE PROCESSING APPARATUS

(76) Inventor: Ichiro Mitsuyoshi, Kyoto-shi (JP)

Correspondence Address: OSTROLENK FABER GERB & SOFFEN, 1180 AVENUE OF THE AMERICAS, NEW YORK, NY, 100368403, US

(21) Appl. No.: 11/959,085

(22) Filed: Dec. 18, 2007

(30) Foreign Application Priority Data
Dec. 27, 2006 (JP) 2006-351997

(51) Int. Cl. B08B 13/00

(52) U.S. Cl. 134/157

(57) ABSTRACT

A reversing unit includes a fixed plate, a first movable plate provided so as to face one surface of the fixed plate, a second movable plate provided so as to face the other surface of the fixed plate and the rotary actuator. The rotary actuator rotates the first movable plate, the second movable plate and the fixed plate around a horizontal axis. In the reversing unit, a substrate before a back surface cleaning processing is reversed while being held by support pins of the first movable plate and support pins of the fixed plate, and the substrate after the back surface cleaning processing is reversed while being held by support pins of the second movable plate and the support pins of the fixed plate.

### BACKGROUND OF THE INVENTION

1. Field of the Invention

The present invention relates to a substrate processing apparatus that subjects a substrate to processing.

2. Description of the Background Art

Substrate processing apparatuses have been conventionally used to perform various types of processings on substrates such as semiconductor wafers, glass substrates for photomasks, glass substrates for liquid crystal displays, glass substrates for optical disks or the like.

For example, a substrate processing apparatus that performs a cleaning processing on a back surface of a substrate is provided with a substrate reversing device for reversing the top surface and the back surface of the substrate. For example, the substrate processing apparatus including the substrate reversing device is described in JP 2006-12880 A.

Such a substrate processing apparatus reverses the substrate by the substrate reversing device before performing the cleaning processing on the back surface of the substrate so that the back surface thereof is directed upward. After the cleaning processing is performed on the back surface of the substrate, the substrate is reversed again by the substrate reversing device so that the top surface of the substrate is directed upward.

However, in the substrate processing apparatus mentioned above, contaminants on the back surface of the substrate on which the cleaning processing has not been performed adhere to the substrate reversing device, and the contaminants adhering to the substrate reversing device transfer to the substrate after the cleaning processing in some cases. In this case, processing defects are likely to occur on the substrate, if the subsequent processing is performed on the substrate that is contaminated.

### SUMMARY OF THE INVENTION

It is an object of the present invention to provide a substrate processing apparatus in which a substrate is prevented from being contaminated after a cleaning processing of a back surface of the substrate.

(1) According to an aspect of the present invention, a substrate processing apparatus that performs processing on a substrate having a top surface and a back surface includes a first cleaning processing unit that cleans the back surface of the substrate, a reversing device that reverses the top surface and the back surface of the substrate and a first transport device that transports the substrate between the first cleaning processing unit and the reversing device, wherein the reversing device includes a first holding mechanism that holds the substrate, a second holding mechanism that holds the substrate, and a rotating mechanism that rotates the first and second holding mechanisms around substantially horizontal axes, respectively, and the first transport device carries the substrate before cleaning by the first cleaning processing unit into the first holding mechanism of the reversing device, and carries the substrate after the cleaning by the first cleaning processing unit into the second holding mechanism of the reversing device.

In this substrate processing apparatus, the substrate is carried into the first holding mechanism of the reversing device by the first transport device before the cleaning by the first cleaning processing unit. Here, the top surface of the substrate is directed upward. The first holding mechanism is rotated around the substantially horizontal axis by the rotating mechanism while holding the substrate. Thus, the top surface and the back surface of the substrate held by the first holding mechanism are reversed, and the back surface of the substrate is directed upward. The back surface of the substrate is cleaned by the first cleaning processing unit while being directed upward.

After the back surface of the substrate is cleaned by the first cleaning processing unit, the substrate is carried into the second holding mechanism of the reversing device by the first transport device. The second holding mechanism is rotated around the substantially horizontal axis by the rotating mechanism while holding the substrate. Thus, the top surface and the back surface of the substrate are reversed, and the substrate is returned to the state where the top surface thereof is directed upward.

Accordingly, the contaminants will not be transferred to the substrate after the cleaning by the first cleaning processing unit via the reversing device even though the back surface of the substrate before the cleaning by the first cleaning processing unit is contaminated. Thus, the substrate after the cleaning by the first cleaning processing unit can be kept clean, and therefore processing defects of the substrate resulting from contamination of the substrate can be prevented.

(2) The rotating mechanism may include a common rotating device that integrally rotates the first and second holding mechanisms around the substantially horizontal axis.

In this case, since the first and second holding mechanisms can be integrally rotated by the common rotating device, the space occupied by the reversing device can be reduced compared to the case where a plurality of rotating device are used. Thus, the space can be saved in the substrate processing apparatus.

(3) The first and second holding mechanisms may include a common reverse holding member that has one surface and the other surface, the first holding mechanism may include a plurality of first supporters that are provided on the one surface of the common reverse holding member and support a periphery of the substrate, a first reverse holding member that is provided so as to face the one surface of the common reverse holding member, a plurality of second supporters that are provided on a surface of the first reverse holding member that faces the common reverse holding member and support the periphery of the substrate, and a first driving mechanism that moves the first reverse holding member relative to the common reverse holding member so that the first reverse holding member is selectively shifted between a first state where the first reverse holding member and the common reverse holding member are spaced apart from each other and a second state where the first reverse holding member and the common reverse holding member are close to each other, and the second holding mechanism may include a plurality of third supporters that are provided on the other surface of the common reverse holding member and support the periphery of the substrate, a second reverse holding member that is provided so as to face the other surface of the common reverse holding member, a plurality of fourth supporters that are provided on a surface of the second reverse holding member that faces the common reverse holding member and support the periphery of the substrate, and a second driving mechanism that moves the second reverse holding member relative to the common reverse holding member so that the second reverse holding member is selectively shifted between a third state where the second reverse holding member and the common reverse holding member are spaced apart from each other and a fourth state where the second reverse holding member and the common reverse holding member are close to each other.

In this case, the substrate before the cleaning by the first cleaning processing unit is carried in between the plurality of first supporters provided on the one surface of the common reverse holding member and the plurality of second supporters provided on the surface of the first reverse holding member facing the common reverse holding member in the first state where the first reverse holding member and the common reverse holding member are spaced apart from each other. In the state, the first reverse holding member is moved by the first driving mechanism so as to be close to the common reverse holding member, and the first reverse holding member is shifted to the second state where the first reverse holding member and the common reverse holding member are close to each other. Accordingly, the periphery of the substrate before the cleaning by the first cleaning processing unit is held by the plurality of first and second supporters.

In addition, the substrate after the first cleaning by the cleaning processing unit is carried in between the plurality of third supporters provided on the other surface of the common reverse holding member and the plurality of fourth supporters provided on the surface of the second reverse holding member facing the common reverse holding member in the third state where the second reverse holding member and the common reverse holding member are spaced apart from each other. In the state, the second reverse holding member is moved by the second driving mechanism so as to be close to the common reverse holding member, and the second reverse holding member is shifted to the fourth state where the second reverse holding member and the common reverse holding member are close to each other. Thus, the periphery of the substrate after the cleaning by the first cleaning processing unit is held by the plurality of third and fourth supporters.

As described above, the substrate before the cleaning by the first cleaning processing unit is held by the plurality of first and second supporters of the first holding mechanism. Meanwhile, the substrate after the cleaning by the first cleaning processing unit is held by the plurality of third and fourth supporters of the second holding mechanism.

(4) The rotating mechanism may include a first rotating device that rotates the first holding mechanism around the substantially horizontal axis, and a second rotating device that rotates the second holding mechanism around the substantially horizontal axis.

In this case, the first holding mechanism is rotated by the first rotating device around the substantially horizontal axis, so that the top surface and the back surface of the substrate held by the first holding mechanism before the cleaning by the first cleaning processing unit are reversed. Moreover, the second holding mechanism is rotated by the second rotating device around the substantially horizontal axis, so that the top surface and the back surface of the substrate held by the second holding mechanism after the cleaning by the first cleaning processing unit are reversed.

(5) The first transport device may include first and second transport holders that hold a lower surface of the substrate, the first transport holder may hold the lower surface of the substrate when the lower surface of the substrate is a back surface before the cleaning by the first cleaning processing unit, and the second transport holder may hold the lower surface of the substrate when the lower surface of the substrate is the back surface after the cleaning by the first cleaning processing unit.

In this case, the different transport holders are used when holding the back surface of the substrate before the cleaning by the first cleaning processing unit and when holding the back surface of the substrate after the cleaning by the first cleaning processing unit, respectively. Therefore, the contaminants will not be transferred to the back surface of the substrate after the cleaning by the first cleaning processing unit, even though the back surface of the substrate before the cleaning by the first cleaning processing unit is contaminated. Accordingly, the substrate after the cleaning by the first cleaning processing unit can be kept clean.

(6) The substrate processing apparatus may further include a container platform on which a storing container that stores the substrate is placed, first and second interfaces for receiving and transferring the substrate, a second transport device that transports the substrate between the storing container placed on the container platform and the first and second interfaces, wherein the second transport device may include third and fourth transport holders that hold the substrate, transport the substrate before the cleaning by the first cleaning processing unit from the storing container placed on the container platform to the first interface by the third transport holder, and transport the substrate after the cleaning by the first cleaning processing unit from the second interface to the storing container placed on the container platform by the fourth transport holder, and the first transport device may hold the substrate by the first transport holder in a transport path from the first interface to the first reversing mechanism, and hold the substrate by the second transport holder in a transport path from the second reversing mechanism to the second interface.

In this case, the second transport device uses the third transport holder when transporting the substrate before the cleaning by the first cleaning processing unit, and uses the fourth transport holder when transporting the substrate after the cleaning by the first cleaning processing unit. Therefore, the contaminants will not be transferred to the substrate after the cleaning by the first cleaning processing unit via the second transport device, even though the substrate before the cleaning by the first cleaning processing unit is contaminated.

In addition, the substrate before the cleaning by the first cleaning processing unit is received and transferred from the second transport device to the first transport device through the first interface, and the substrate after the cleaning by the first cleaning processing unit is received and transferred from the first transport device to the second transport device through the second interface. Therefore, the contaminants will not be transferred to the substrate after the cleaning by the first cleaning processing unit via the first and second interfaces, even though the substrate before the cleaning by the first cleaning processing unit is contaminated.

Furthermore, in the transport path from the first interface to the first holding mechanism, the first transport device transports the substrate by the first transport holder with the lower surface of the substrate being the back surface. In the transport path from the second holding mechanism to the second interface, the first transport device transports the substrate by the second transport holder with the lower surface of the substrate being the back surface. Therefore, the contaminants will not be transferred to the back surface of the substrate after the cleaning by the first cleaning processing unit via the first transport device, even though the back surface of the substrate before the cleaning by the first cleaning processing unit is contaminated.

(7) The substrate processing apparatus may further include a second cleaning processing unit that cleans the top surface of the substrate, wherein the first transport device may transport the substrate among the first cleaning processing unit, the second cleaning processing unit and the reversing device.

In this case, the top surface of the substrate is cleaned by the second cleaning processing unit, so that the processing defects of the substrate resulting from contamination of the top surface of the substrate is prevented.

According to the present invention, the contaminants will not be transferred to the substrate after the cleaning by the first cleaning processing unit via the reversing device, even though the back surface of the substrate before the cleaning by the first cleaning processing unit is contaminated. Thus, the substrate after the cleaning by the first cleaning processing unit can be kept clean, and the processing defects of the substrate resulting from the contamination of the substrate can be prevented.

Other features, elements, characteristics, and advantages of the present invention will become more apparent from the following description of preferred embodiments of the present invention with reference to the attached drawings.

### BRIEF DESCRIPTION OF THE DRAWINGS

FIG. 1 is a diagram showing a configuration of a substrate processing apparatus according to a first embodiment;

FIG. 2 is a diagram showing the configuration of the substrate processing apparatus according to the first embodiment;

FIG. 3 is a diagram for use in explaining details of a main robot;

FIG. 4 is a diagram for use in explaining details of a reversing unit;

FIG. 5 is a diagram showing operations of the reversing unit in a case where a substrate before a cleaning processing of a back surface thereof is reversed;

FIG. 6 is a diagram showing operations of the reversing unit in a case where the substrate after the cleaning processing of the back surface thereof is reversed;

FIG. 7 is a diagram showing operations of the main robot when the substrate is carried into and out of the reversing unit;

FIG. 8 is a diagram showing the operations of the main robot when the substrate is carried into and out of the reversing unit;

FIG. 9 is a diagram for use in explaining a configuration of a top surface cleaning unit;

FIG. 10 is a diagram for use in explaining a configuration of a back surface cleaning unit;

FIG. 11 is a diagram showing a configuration of a substrate processing apparatus according to a second embodiment; and

FIG. 12 is a diagram for use in explaining details of a reversing unit according to the second embodiment.

### DESCRIPTION OF THE PREFERRED EMBODIMENTS

A substrate processing apparatus according to one embodiment of the present invention will now be described with reference to drawings.

In the following description, a substrate refers to a semiconductor wafer, a glass substrate for a liquid crystal display, a glass substrate for a PDP (plasma display panel), a glass substrate for a photomask, and a substrate for an optical disk or the like.

In the following description, a surface of the substrate on which a variety of patterns such as a circuit pattern or the like are to be formed is referred to as a top surface, while the opposite surface thereof is referred to as a back surface. In addition, a surface of the substrate directed downward is referred to as a lower surface, while a surface of the substrate directed upward is referred to as an upper surface.

### (1) First Embodiment

A substrate processing apparatus according to a first embodiment will now be described with reference to drawings.

(1-1) Configuration of the Substrate Processing Apparatus

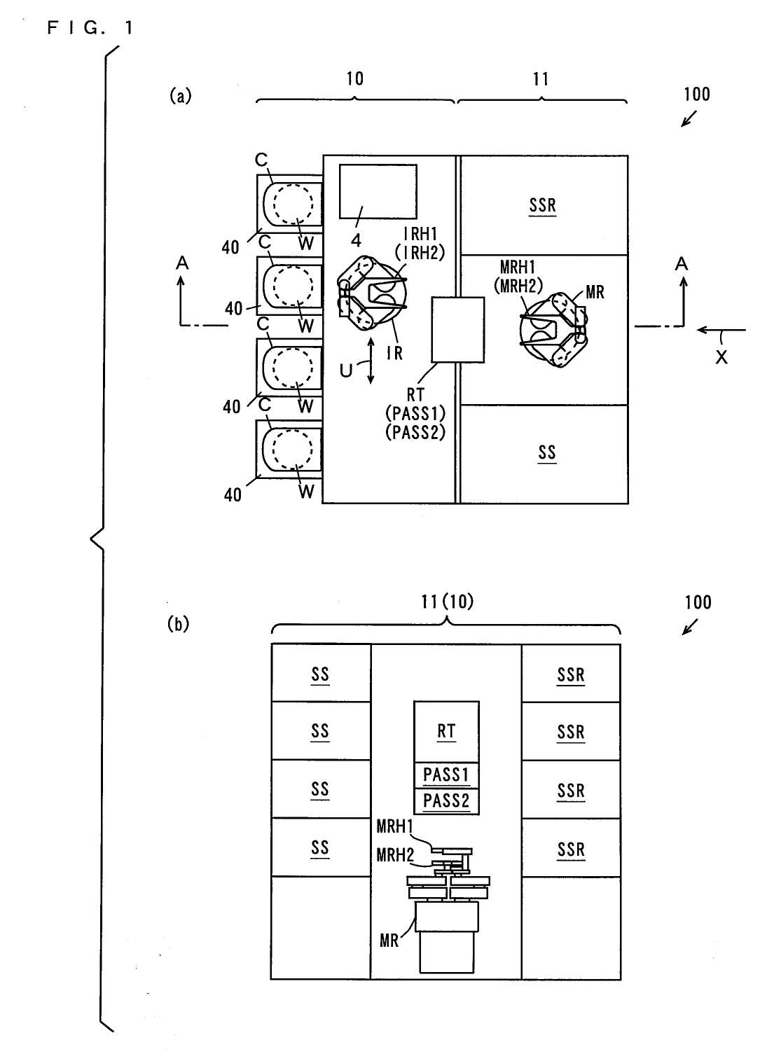

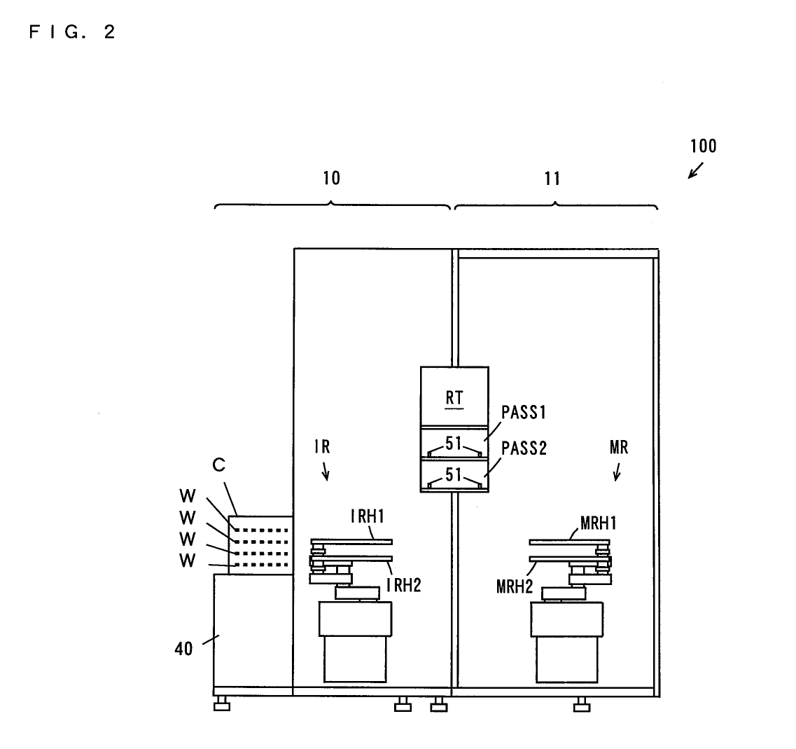

FIG. 1(a) is a plan view of the substrate processing apparatus according to a first embodiment of the present invention, and FIG. 1(b) is a schematic side view in which the substrate processing apparatus of FIG. 1(a) is seen from the direction of the arrow X. FIG. 2 is a diagram schematically showing a cross section of FIG. 1(a) taken along the line A-A.

As shown in FIG. 1(a), the substrate processing apparatus 100 includes an indexer block 10 and a processing block 11. The indexer block 10 and the processing block 11 are provided in parallel to each other.

The indexer block 10 is provided with a plurality of carrier platforms 40, an indexer robot IR and a controller 4. Carriers C that store a plurality of substrates W in multiple stages are placed on the carrier platforms 40, respectively. The indexer robot IR is constructed so that it can move in the direction of the arrow U (FIG. 1(a)), rotate around a vertical axis and move up and down. The indexer robot IR has hands IRH1, IRH2 provided one above the other for receiving and transferring the substrate W. The hands IRH1, IRH2 hold a peripheral portion of the lower surface of the substrate W and an outer circumference of the substrate W. The controller 4 is composed of a computer or the like including a CPU (central processing unit), and controls each unit in the substrate processing apparatus 100.

As shown in FIG. 1(b), a plurality of top surface cleaning units SS (four units in this example), a plurality of back surface cleaning units SSR (four units in this example) and a main robot MR are provided in the processing block 11. One side of the processing block 11 has a vertical stack of the plurality of top surface cleaning units SS, and the other side of the processing block 11 has a vertical stack of the plurality of back surface cleaning units SSR. The main robot MR is provided between the plurality of top surface cleaning units SS and the plurality of back surface cleaning units SSR. The main robot MR is constructed so that it can rotate around a vertical axis and move up and down. Moreover, the main robot MR has hands MRH1, MRH2 provided one above the other for receiving and transferring the substrate W. The hands MRH1, MRH2 hold the peripheral portion of the lower surface of the substrate W and the outer circumference of the substrate W. Details of the main robot MR will be described later.

As shown in FIG. 2, a reversing unit RT for reversing the substrate W and substrate platforms PASS1, PASS2 for receiving and transferring the substrate between the indexer robot IR and the main robot MR are provided one above another between the indexer block 10 and the processing block 11. Details of the reversing unit RT will be described later.

The upper substrate platform PASS1 is used when the substrate W is transported from the processing block 11 to the indexer block 10, and the lower substrate platform PASS 2 is used when the substrate W is transported from the indexer block 10 to the processing block 11.

Optical sensors (not shown) that detect the presence or absence of the substrate W are provided in the substrate platforms PASS1, PASS2. This enables determination to be made whether or not the substrate W is placed on the substrate platform PASS1, PASS2. In addition, a plurality of support pins 51 that support the lower surface of the substrate W are attached to each of the substrate platforms PASS1, PASS2. The substrate W is temporarily placed on the support pins 51 of the substrate platforms PASS1, PASS2, when the substrate W is received and transferred between the indexer robot IR and the main robot MR.

(1-2) Summary of Operations of the Substrate Processing Apparatus

Next, a summary of operations of the substrate processing apparatus 100 will be described with reference to FIG. 1 and FIG. 2. Note that an operation of each component of the substrate processing apparatus 100, described below, is controlled by the controller 4 of FIG. 1.

First, the indexer robot IR takes out the unprocessed substrate W from one of the carriers C placed on the carrier platform 40 by use of the lower hand IRH2. At this point, the top surface of the substrate W is directed upward. The hand IRH2 of the indexer robot IR holds the peripheral portion of the back surface of the substrate W and the outer circumference of the substrate W. The indexer robot IR turns around the vertical axis while moving in the direction of the arrow U, and places the unprocessed substrate W on the substrate platform PASS2.

The main robot MR takes out the substrate W from the substrate platform PASS2, and subsequently carries it into the top surface cleaning unit SS by use of the lower hand MRH2. In this case, the lower hand MRH2 of the main robot MR holds the peripheral portion of the back surface of the substrate W and the circumference of the substrate W. The top surface cleaning unit SS performs a cleaning processing on the top surface of the substrate W. The cleaning processing of the top surface of the substrate W is hereinafter referred to as the top surface cleaning processing. Details of the top surface cleaning processing will be described later.

Then, the main robot MR carries the substrate W after the top surface cleaning processing out of the top surface cleaning unit SS, and subsequently carries it into the reversing unit RT by use of the lower hand MRH2. In this case, the lower hand MRH2 of the main robot MR holds the peripheral portion of the back surface of the substrate and the outer circumference of the substrate W. The reversing unit RT reverses the substrate W carried therein so that the back surface of the substrate W is directed upward. Then, the main robot MR carries the substrate W out of the reversing unit RT, and subsequently carries it into the back surface cleaning unit SSR by use of the upper hand MRH1. In this case, the upper hand MRH1 of the main robot MR holds the peripheral portion of the clean top surface of the substrate W and the outer circumference of the substrate W.

The back surface cleaning unit SSR performs a cleaning processing on the back surface of the substrate W. The cleaning processing of the back surface of the substrate W is hereinafter referred to as the back surface cleaning processing. Details of the back surface cleaning processing will be described later. Next, the main robot MR carries the substrate W out of the back surface cleaning unit SSR and subsequently carries it into the reversing unit RT by use of the upper hand MRH1. In this case, the upper hand MRH1 of the main robot MR holds the peripheral portion of the clean top surface of the substrate W and the outer circumference of the substrate W. The reversing unit RT again reverses the substrate W so that the top surface thereof is directed upward.

The main robot MR carries the substrate W out of the reversing unit RT and subsequently places it on the substrate platform PASS1 by use of the upper hand MRH1. In this case, the upper hand MRH1 of the main robot MR holds the peripheral portion of the clean back surface of the substrate W and the outer circumference of the substrate W. Then, the indexer robot IR takes out the clean substrate W from the substrate platform PASS1 and stores it in the carrier C by use of the upper hand IRH1.

(1-3) Configuration of the Main Robot

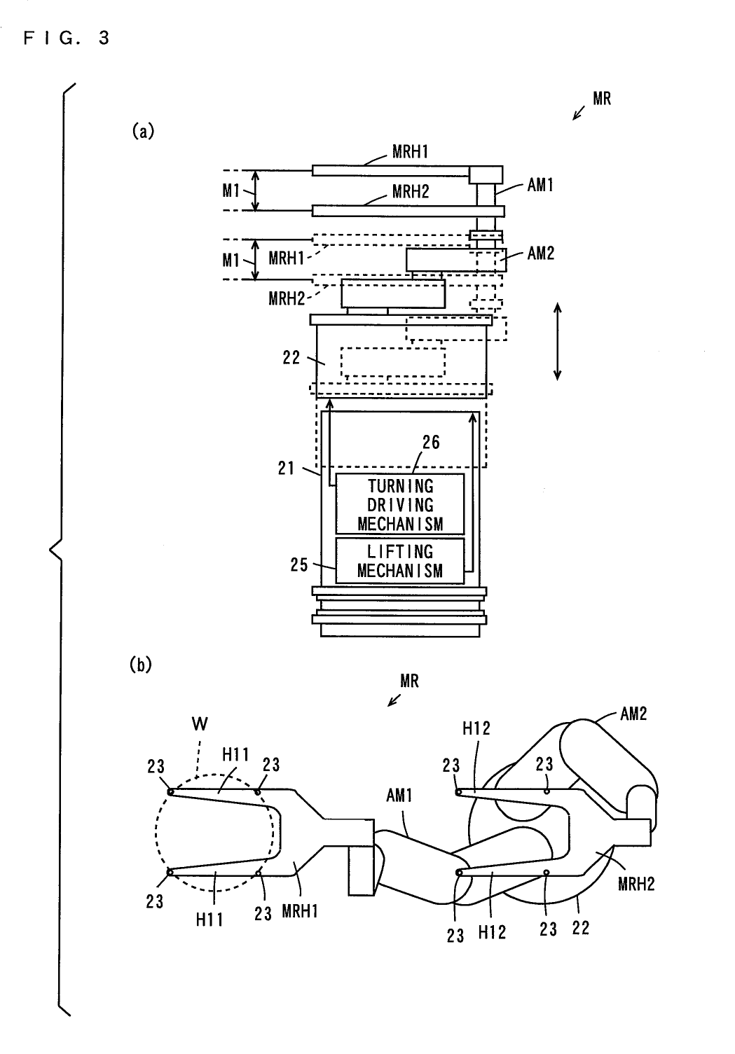

Details of the configuration of the main robot MR will now be described. FIG. 3(a) is a side view of the main robot MR, and FIG. 3(b) is a plan view of the main robot MR.

As shown in FIG. 3(a) and FIG. 3(b), the main robot MR includes a base 21, to which a moving portion 22 is attached so as to be able to vertically move and turn with respect to the base 21. The hands MRH1 and MRH2 are connected to the moving portion 22 by multi-joint type arms AM1 and AM2, respectively.

The moving portion 22 is moved up and down by a lifting mechanism 25 provided in the base 21 while being turned around a vertical axis by a turning driving mechanism 26 provided in the base 21. The multi-joint type arms AM1, AM2 are independently driven by driving mechanisms that are not shown, respectively, and horizontally move the respective hands MRH1, MRH2 forward and backward while keeping them in fixed postures. Each of the hands MRH1, MRH2 is arranged to have a certain height with respective to the moving portion 22, and the hand MRH1 is positioned above the hand MRH2. A difference Ml (FIG. 3 (a)) in height between the hand MRH1 and the hand MRH2 is maintained to be constant.

The hands MRH1, MRH2 have the same shape and are formed to be approximately U-shaped respectively. The hand MRH1 has two claw portions H11 extending substantially in parallel to each other and the hand MRH2 has two claw portions H12 extending substantially in parallel to each other. Furthermore, a plurality of support pins 23 are attached on the hands MRH1, MRH2, respectively. In the present embodiment, the four support pins 23 are attached on the upper surface of the hands MRH1, MRH2, respectively, at substantially equal distances from each other along the outer circumference of the substrate W placed thereon. The peripheral portion of the lower surface of the substrate W and the outer circumference of the substrate W are held by the four support pins 23.

(1-4) Details of the Reversing Unit

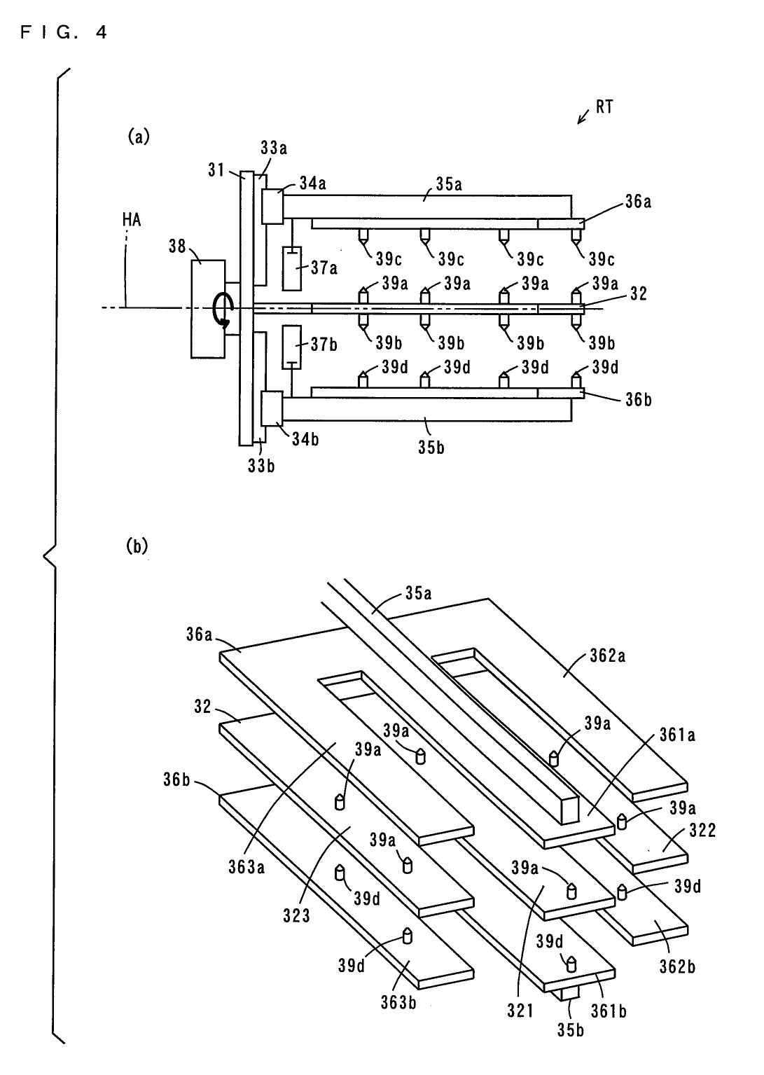

Next, details of the reversing unit RT will be described. FIG. 4(a) is a side view of the reversing unit RT, and FIG. 4(b) is a perspective view of the reversing unit RT.

As shown in FIG. 4(a), the reversing unit RT includes a support plate 31, a fixed plate 32, a pair of linear guides 33a, 33b, a pair of support members 35a, 35b, a pair of cylinders 37a, 37b, a first movable plate 36a, a second movable plate 36b and a rotary actuator 38.

The support plate 31 is provided so as to extend vertically, to which the fixed plate 32 is attached so that it extends horizontally from the center of one surface of the support plate 31. The linear guide 33a extending in a vertical direction to the fixed plate 32 is provided in a region of the support plate 31 on one surface side of the fixed plate 32. In addition, the linear guide 33b extending in the vertical direction to the fixed plate 32 is provided in the region of the support plate 31 on the other surface side of the fixed plate 32. The linear guides 33a, 33b are provided symmetrically with respect to the fixed plate 32.

The support member 35a is provided so as to extend in a parallel direction to the fixed plate 32 on the one surface side of the fixed plate 32. The support member 35a is slidably attached to the linear guide 33a by a coupling member 34a. The cylinder 37a is connected to the support member 35a and moves the support member 35a up and down along the linear guide 33a. In this case, the support member 35a moves in the vertical direction to the fixed plate 32 while being maintained in a fixed posture. Moreover, the first movable plate 36a is attached to the support member 35a so as to face the one surface of the fixed plate 32.

On the other surface side of the fixed plate 32, the support member 35b is provided so as to extend in the parallel direction to the fixed plate 32. The support member 35b is slidably attached to the linear guide 33b by a coupling member 34b. The support member 35b is connected to the cylinder 37b, which moves the support member 35b up and down along the linear guide 33b. In this case, the support member 35b moves in the vertical direction to the fixed plate 32 while being maintained in a fixed posture. Furthermore, the second movable plate 36b is attached to the support member 35b so as to face the other surface of the fixed plate 32.

The rotary actuator 38 rotates the support plate 31 around the horizontal axis HA. Accordingly, the first movable plate 36a, the second movable plate 36b and the fixed plate 32 that are coupled to the support plate 31 rotate around the horizontal axis HA.

As shown in FIG. 4(b), the first movable plate 36a, the fixed plate 32 and the second movable plate 36b have substantially the same shape.

The first movable plate 36a includes a central support portion 361a extending along the support member 35a and side portions 362a, 363a extending in parallel to the central support portion 361a on both sides of the central support portion 361a. The side portions 362a, 363a are provided symmetrically with respect to the central support portion 361a. The respective one tips of the central support portion 361a and the side portions 362a, 363a are coupled to one another on the support plate 31 (FIG. 4(a)) side. In this way, the first movable plate 36a is formed to be substantially E-shaped, and a striped notch region is formed between the central support portion 361a and the side portions 362a, 363a.

The fixed plate 32 includes a central support portion 321 and side portions 322, 323 corresponding to the central support portion 361a and the side portions 362a, 363a of the first movable plate 36a, and the respective one tips of the central support portion 321 and the side portions 322, 323 are coupled with one another on the support plate 31 side. Thus, the fixed plate 32 is formed to be substantially E-shaped, and a striped notch region is formed between the central support portion 321 and the side portions 322, 323.

The second movable plate 36b includes a central support portion 361b and side portions 362b, 363b corresponding to the central support portion 361a and the side portions 362a, 363a of the first movable plate 36a, and the respective one tips of the central support portion 361b and the side portions 362b, 363b are coupled with one another on the support plate 31 side. Accordingly, the second movable plate 36b is formed to be substantially E-shaped, and a striped notch region is formed between the central support portion 361a and the side portions 362b, 363b.

As shown in FIG. 4(a), a plurality of support pins 39a are provided on the one surface of the fixed plate 32 facing the first movable plate 36a, and a plurality of support pins 39b are provided on the other surface of the fixed plate 32. Moreover, a plurality of support pins 39c are provided on one surface of the first movable plate 36a facing the fixed plate 32, and a plurality of support pins 39d are provided on one surface of the second movable plate 36b facing the fixed plate 32.

In the present embodiment, respective six pieces of the support pins 39a, 39b, 39c, 39d are provided. These support pins 39a, 39b, 39c, 39d are arranged along the outer circumference of the substrate W that is carried into the reversing unit RT.

(1-5) Operations of the Reversing Unit

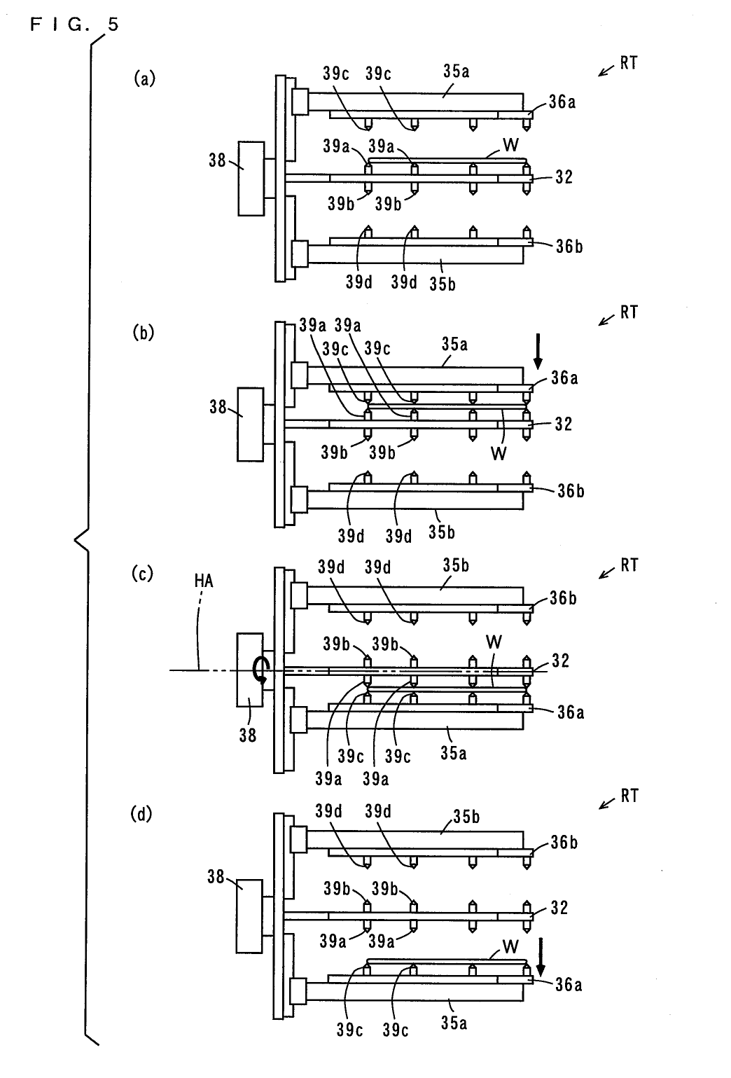

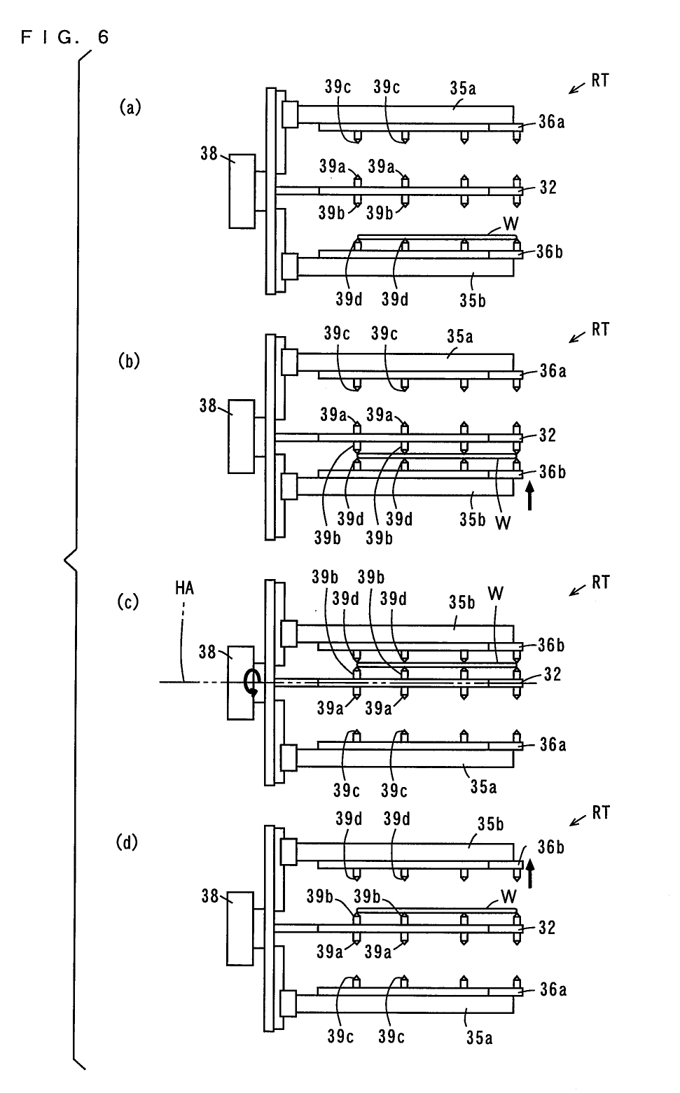

Next, the operations of the reversing unit RT will be described. FIG. 5 shows the operations of the reversing unit RT in a case where the substrate W before the back surface cleaning processing is reversed, and FIG. 6 shows the operations of the reversing unit RT in a case where the substrate W after the back surface cleaning processing is reversed.

First, the operations of the reversing unit RT in the case where the substrate W before the back surface cleaning processing is reversed will be described with reference to FIG. 5. As shown in FIG. 5(a), the substrate W before the back surface cleaning processing is placed on the support pins 39a on the fixed plate 32 by the hand MRH2 of the main robot MR (FIG. 3) with the first movable plate 36a positioned above the fixed plate 32, and the first movable plate 36a, the fixed plate 32 and the second movable plate 36b maintained in horizontal postures. At this point, the top surface of the substrate W is directed upward. Note that details of the steps of receiving and transferring the substrate W by the main robot MR will be described later.

Then, as shown in FIG. 5(b), the support member 35a is lowered by the cylinder 37a (FIG. 4(a)). Thus, the first movable plate 36a is lowered, and the distance between the first movable plate 36a and the fixed plate 32 is shortened. The first movable plate 36a is lowered by a predetermined distance, so that the peripheral portion and the outer circumference of the substrate W are held by the support pins 39a on the fixed plate 32 and the support pins 39c on the first movable plate 36a. In this state, the first movable plate 36a, the fixed plate 32 and the second movable plate 36b are integrally rotated around the horizontal axis HA by 180 degrees by the rotary actuator 38 as shown in FIG. 5(c). Accordingly, the substrate W is reversed, and the back surface of the substrate W is directed upward.

The support member 35a is subsequently lowered by the cylinder 37a as shown in FIG. 5(d). Thus, the first movable plate 36a is lowered, and the distance between the first movable plate 36 and the fixed plate 32 is lengthened. Therefore, the substrate W is brought into a state where it is held by the support pins 39c on the first movable plate 36a. Then, the substrate W with the back surface thereof directed upward is carried out of the reversing unit RT by the hand MRH1 of the main robot MR.

Next, the operations of the reversing unit RT in the case where the substrate W after the back surface cleaning processing is reversed will be described with reference to FIG. 6. As shown in FIG. 6(a), the substrate W after the back surface cleaning processing is placed on the support pins 39d on the second movable plate 36b by the hand MRH1 of the main robot MR (FIG. 3) with the first movable plate 36a positioned above the fixed plate 32, and the first movable plate 36a, the fixed plate 32 and the second movable plate 36b maintained in the horizontal postures. At this point, the back surface of the substrate W is directed upward.

Then, as shown in FIG. 6(b), the support member 35b is lifted by the cylinder 37b(FIG. 4(a)). Thus, the second movable plate 36b is lifted, so that the distance between the second movable plate 36b and the fixed plate 32 is shortened. The second movable plate 36b is lifted by a predetermined distance, so that the peripheral portion and the outer circumference of the substrate W are held by the support pins 39b on the fixed plate 32 and the support pins 39d on the second movable plate 36b. In this state, the first movable plate 36a, the second movable plate 36b and the fixed plate 32 are rotated around the horizontal axis HA by 180 degrees by the rotary actuator 38 as shown in FIG. 6(c). In this way, the substrate W is reversed, and the top surface of the substrate W is directed upward.

Next, as shown in FIG. 6(d), the support member 35b is moved up by the cylinder 37b. Thus, the second movable plate 36b is lifted, and the distance between the second movable plate 36b and the fixed plate 32 is lengthened. Therefore, the substrate W is brought into a state where it is held by the support pins 39b on the fixed plate 32. Then, the substrate W with the top surface thereof directed upward is carried out of the reversing unit RT by the hand MRH1 of the main robot MR (FIG. 3).

As described above, the substrate W before the back surface cleaning processing is reversed in the state where it is held by the support pins 39c on the first movable plate 36a and the support pins 39a on the fixed plate 32, and the substrate W after the back surface cleaning processing is reversed in the state where it is held by the support pins 39d on the second movable plate 36b and the support pins 39b on the fixed plate 32 in the reversing unit RT.

Note that the substrate W held by the reversing unit RT is in the state where the top surface thereof is directed upward when the substrate W is in a position higher than the horizontal axis HA and in the state where the back surface thereof is directed upward when the substrate W is in a position lower than the horizontal axis HA in the present embodiment. This makes it possible to determine which surface of the substrate W is directed upward by seeing if the substrate W is at the higher position or at the lower position than that of the horizontal axis HA. Thus, determination as to which surface of the substrate W held by the reversing unit RT is directed upward can be made instantaneously, even though the operation of the substrate processing apparatus 100 stops due to the electric outage or the like, for example.

(1-6) Receiving and Transferring the Substrate Between the Main Robot and the Reversing Unit

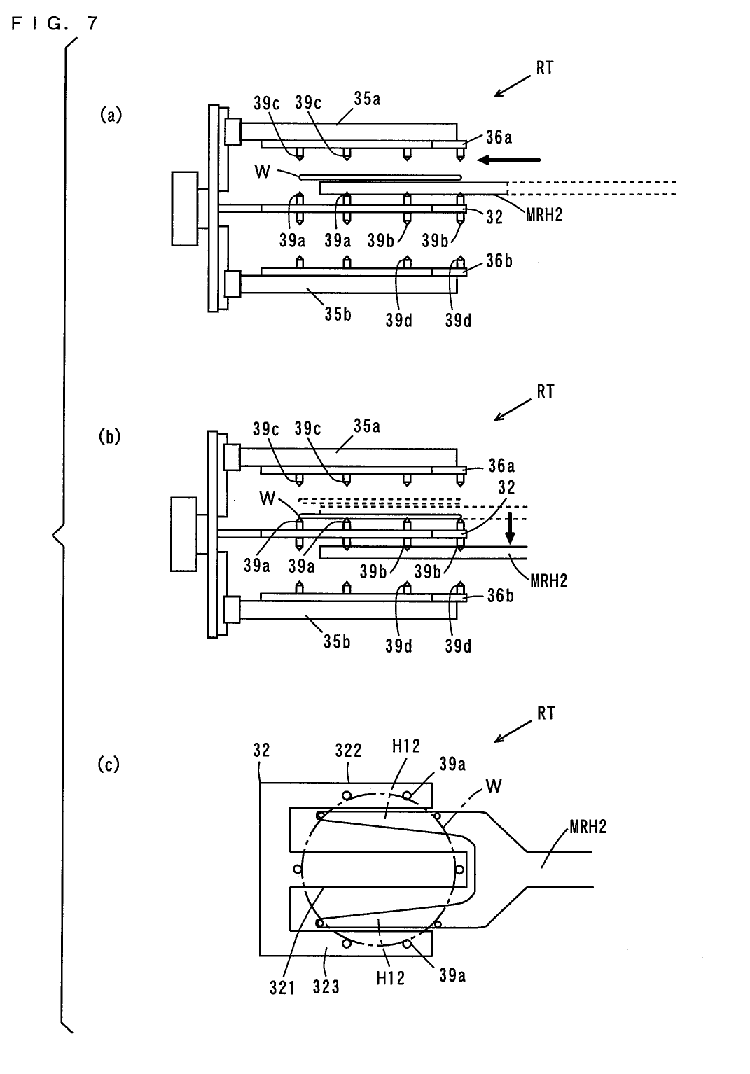

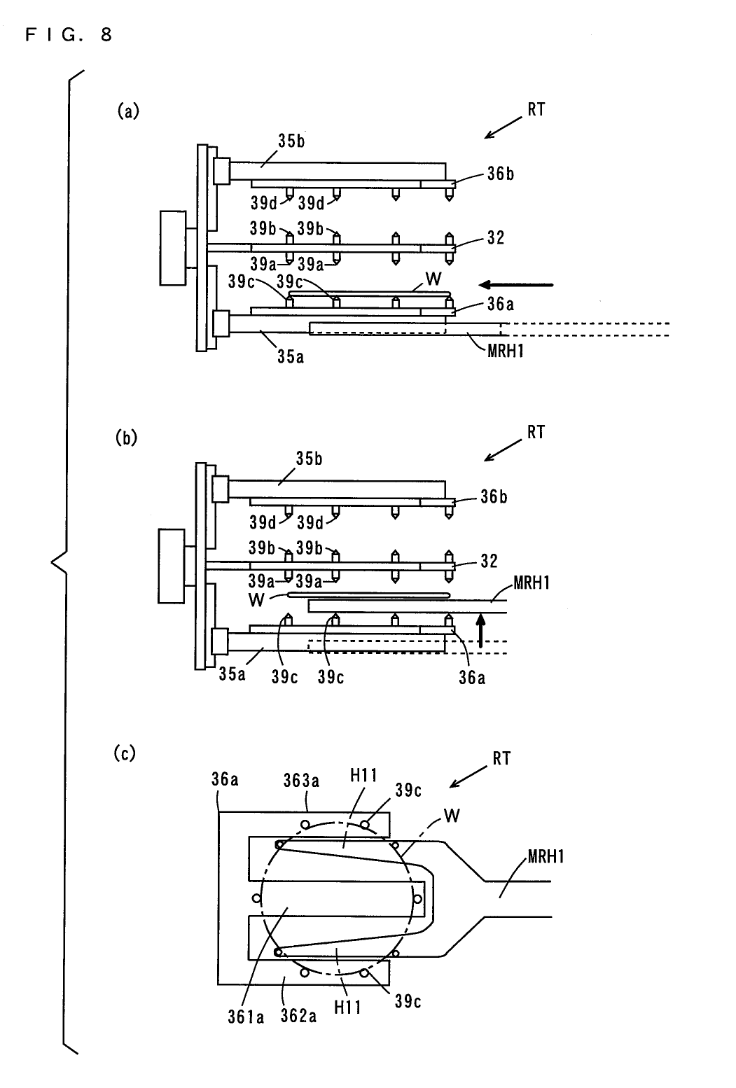

Next, the operations of the main robot MR when the substrate W is carried into the reversing unit RT and the substrate W is carried out of the reversing unit RT will be described in detail. Here, the case where the substrate W before the back surface cleaning processing is carried into the reversing unit RT and the case where the substrate W is subsequently carried out of the reversing unit RT will be described. FIG. 7 and FIG. 8 are diagrams that show the operations of the main robot MR when the substrate W is carried into the reversing unit RT and when the substrate W is carried out of the reversing unit RT.

As shown in FIG. 7(a), the hand MRH2 of the main robot MR advances between the first movable plate 36a and the fixed plate 32 of the reversing unit RT while holding the substrate W before the back surface cleaning processing. As shown in FIG. 7(b), the hand MRH2 is subsequently lowered. In this case, the claw portions H12 of the hand MRH2 are lowered through the notch region between the central support portion 321 and the side portions 322, 323 of the fixed plate 32 as shown in FIG. 7(c). Accordingly, the substrate W held by the hand MRH2 is placed on the support pins 39a on the fixed plate 32. Then, the hand MRH2 withdraws from the reversing unit RT, and the substrate W is reversed by the reversing unit RT as shown in FIG. 5.

The reversed substrate W is supported by the support pins 39c on the first movable plate 36a (see FIG. 5(d)). In this state, the hand MRH1 advances below the first movable plate 36a as shown in FIG. 8(a).

The hand MRH1 is subsequently lifted as shown in FIG. 8(b). In this case, the claw portions H11 of the hand MRH1 are lifted through the notch region between the central support portion 361a and the side portions 362a, 363a of the first movable plate 36a as shown in FIG. 8(c). Thus, the substrate W is received by the hand MRH1. Then, the hand MRH1 withdraws from the reversing unit RT, and therefore the substrate W is carried out of the reversing unit RT.

Note that the following operation is performed when the substrate W after the back surface cleaning processing is carried into the reversing unit RT and carried out of the reversing unit RT. The hand MRH1 that holds the substrate W advances between the second movable plate 36b and the fixed plate 32, and the hand MRH1 is lowered so that the claw portions H11 pass through the notch region between the central support portion 361b and the side portions 362b, 363b of the second movable plate 36b. Accordingly, the substrate W is placed on the support pins 39d on the second movable plate 36b, and the hand MRH1 withdraws from the reversing unit RT. After the substrate W is reversed, the hand MRH1 advances below the fixed plate 32, and is lifted so that the claw portions H11 pass through the notch region between the central support portion 321 and the side portions 322, 323 of the fixed plate 32. Thus, the substrate W is received by the hand MRH1. Then, the hand MRH1 withdraws from the reversing unit RT.

(1-7) Details of the Top Surface Cleaning Unit and the Back Surface Cleaning Unit

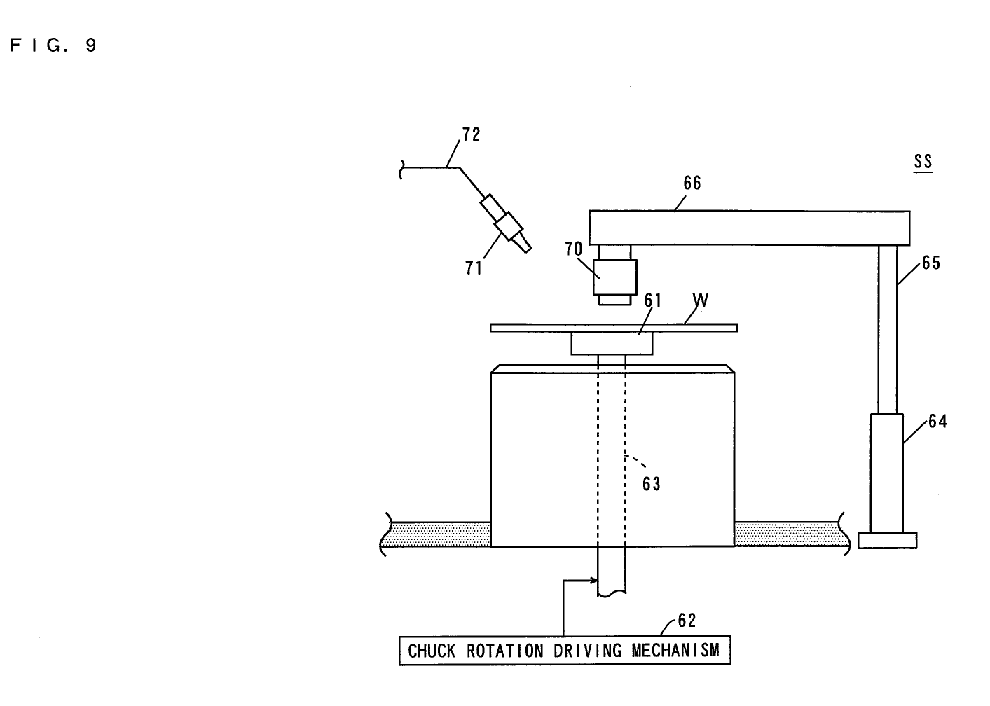

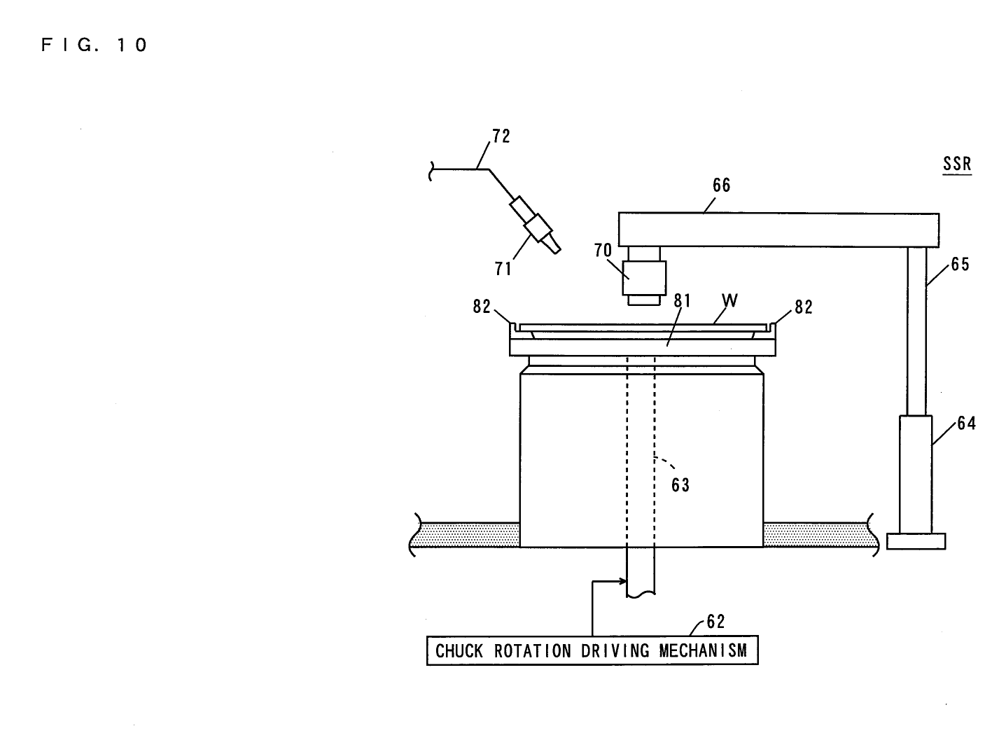

Next, the top surface cleaning unit SS and the back surface cleaning unit SSR shown in FIG. 1 will be described. FIG. 9 is a diagram for explaining the configuration of the top surface cleaning unit SS, and FIG. 10 is a diagram for explaining the configuration of the back surface cleaning unit SSR. In the top surface cleaning unit SS shown in FIG. 9 and the back surface cleaning unit SSR shown in FIG. 10, a cleaning processing of the substrate W by use of a brush (hereinafter referred to as the scrub cleaning processing) is performed.

First, details of the top surface cleaning unit SS are described by use of FIG. 9. As shown in FIG. 9, the top surface cleaning unit SS includes a spin chuck 61 for rotating the substrate W around a vertical axis passing through the center of the substrate W while holding the substrate W horizontally. The spin chuck 61 is secured to the upper end of a rotation shaft 63 that is rotated by a chuck rotation driving mechanism 62.

As described above, the substrate W with the top surface thereof directed upward is carried into the top surface cleaning unit SS. When the scrub cleaning processing and a rinsing processing are performed, the back surface of the substrate W is held by suction on the spin chuck 61.

A motor 64 is provided outside the spin chuck 61. A rotation shaft 65 is connected to the motor 64. An arm 66 is coupled to the rotation shaft 65 so as to extend in a horizontal direction, and a substantially cylindrical brush cleaner 70 is provided on the tip of the arm 66. In addition, above the spin chuck 61, a liquid discharge nozzle 71 is provided for supplying a cleaning liquid or a rinse liquid (pure water) onto the top surface of the substrate W held by the spin chuck 61. A supply pipe 72 is connected to the liquid discharge nozzle 71, and the cleaning liquid and the rinse liquid are selectively supplied to the liquid discharge nozzle 71 through this supply pipe 72.

In the scrub cleaning processing, the motor 64 rotates the rotation shaft 65. Thus, the arm 66 turns within a horizontal plane, and the brush cleaner 70 moves between a position outside the substrate W and a position above the center of the substrate W, centered around the rotation shaft 65. A lifting mechanism (not shown) is provided in the motor 64. The lifting mechanism lifts and lowers the brush cleaner 70 in the position outside the substrate W and the position above the center of the substrate W by lifting and lowering the rotation shaft 65.

When the scrub cleaning processing is started, the substrate W with the top surface thereof directed upward is rotated by the spin chuck 61. Moreover, the cleaning liquid or the rinse liquid is supplied to the liquid discharge nozzle 71 through the supply pipe 72. Thus, the cleaning liquid or the rinse liquid is supplied onto the top surface of the substrate W that rotates. In this state, the brush cleaner 70 is swung and moved up and down by the rotation shaft 65 and the arm 66. Accordingly, the scrub cleaning processing is performed on the top surface of the substrate W. Note that since the suction-type spin chuck 61 is used in the top surface cleaning unit SS, the peripheral portion and the outer circumference of the substrate W can be simultaneously cleaned.

Next, for the back surface cleaning unit SSR, different points from the top surface cleaning unit SS shown in FIG. 9 will be described by use of FIG. 10. As shown in FIG. 10, the back surface cleaning unit SSR includes a mechanical type spin chuck 81 that holds the outer circumference of the substrate W instead of the suction-type spin chuck 61 that holds the lower surface of the substrate W by vacuum suction. When the scrub cleaning processing and the rinsing processing are performed, the substrate W is rotated while being maintained in a horizontal posture with the peripheral portion of the lower surface and the outer circumference thereof held by the spin holding pins 82 on the spin chuck 61.

As described above, the substrate W with the back surface thereof directed upward is carried into the back surface cleaning unit SSR. Therefore, the substrate W is held by the spin chuck 81 with the back surface thereof directed upward. Then, a scrub cleaning processing that is similar to the above described scrub cleaning processing is performed on the back surface of the substrate W.

(1-8) Effects of the First Embodiment

In the first embodiment, the substrate W is held by the support pins 39c on the first movable plate 36a and the support pins 39a on the fixed plate 32 when the substrate W before the back surface cleaning processing is reversed, and the substrate W is held by the support pins 39d on the second movable plate 36b and the support pins 39b on the fixed plate 32 when the substrate W after the back surface cleaning processing is reversed in the reversing unit RT.

In this case, the substrate W is held by different support pins before the back surface cleaning processing and after the back surface cleaning processing, respectively. Therefore, even though the back surface of the substrate W before the back surface cleaning processing is contaminated, the contaminants will not be transferred to the substrate W after the back surface cleaning processing via the reversing unit RT. Accordingly, the back surface of the substrate W after the back surface cleaning processing can be kept clean, and therefore processing defects of the substrate W resulting from contamination of the back surface of the substrate W can be prevented. Moreover, since the substrate W before the back surface cleaning processing and after the back surface cleaning processing is reversed in the single reversing unit RT, the space in the substrate processing apparatus 100 can be saved.

In addition, the indexer robot IR uses the hand IRH2 to hold the unprocessed substrate W, and uses the hand IRH1 to hold the substrate W that has been subjected to the top surface cleaning processing and the back surface cleaning processing in the first embodiment. In this case, even though the unprocessed substrate W is contaminated, the contaminants will not be transferred to the substrate W after the top surface cleaning processing and the back surface cleaning processing via the indexer robot IR. Accordingly, the substrate W after the top surface cleaning processing and the back surface cleaning processing can be kept clean.

Moreover, the main robot MR uses the hand MRH2 to hold the back surface of the substrate W before the back surface cleaning processing, and uses the hand MRH1 to hold the top surface of the substrate W after the top surface cleaning processing and the back surface of the substrate W after the back surface cleaning processing. In this case, even though the back surface of the substrate W before the back surface cleaning processing is contaminated, the contaminants will not be transferred to the substrate W after the top surface cleaning processing or the back surface cleaning processing via the main robot MR. Thus, the substrate W after the top surface cleaning processing and the back surface cleaning processing can be kept clean.

Furthermore, the substrate W before the top surface cleaning processing is transferred from the indexer robot IR to the main robot MR through the substrate platform PASS2, and the substrate W after the back surface cleaning processing is transferred from the main robot MR to the indexer robot IR through the substrate platform PASS1. In this case, even though the substrate W before the top surface cleaning processing is contaminated, the contaminants will not be transferred to the substrate W after the back surface cleaning processing. Thus, the substrate W after the top surface cleaning processing and the back surface cleaning processing can be kept clean.

In addition, since the striped notch region is formed in the first movable plate 36a, the second movable plate 36b and the fixed plate 32 of the reversing unit RT, the hands MRH1, MRH2 of the main robot MR can move in a vertical direction through the notch region in the first embodiment.

In this case, even though the lengths of the support pins 39a, 39b, 39c, 39d are short, the hands MRH1, MRH2 can place the substrate W on the support pins 39a, 39b, 39c, 39d without coming into contact with the first movable plate 36a, the second movable plate 36b and the fixed plate 32 by being lowered through the notch region. Moreover, even though the lengths of the support pins 39a, 39b, 39c, 39d are short, the hands MRH1, MRH2 can receive the substrate W placed on the support pins 39a, 39b, 39c, 39d without coming into contact with the first movable plate 36a, the second movable plate 36b and the fixed plate 32 by being lifted through the notch region. Thus, the reversing unit RT can be reduced in size.

### (2) Second Embodiment

For a substrate processing apparatus according to the second embodiment of the present invention, different points from the first embodiment will now be described.

(2-1) Configuration of the Substrate Processing Apparatus

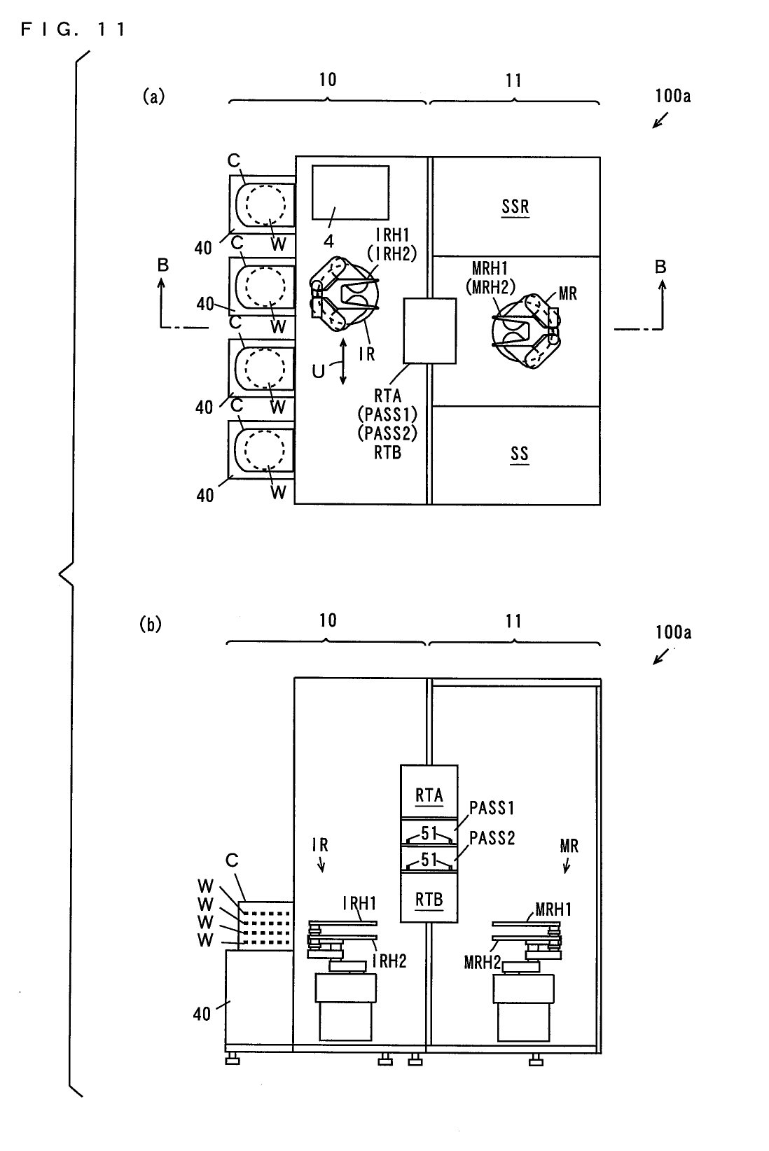

FIG. 11(a) is a plan view of the substrate processing apparatus according to the second embodiment of the present invention, and FIG. 11(b) is a sectional view taken along the line B-B of the substrate processing apparatus of FIG. 11(a)

As shown in FIG. 11(a) and FIG. 11(b), the substrate processing apparatus 100a according to the second embodiment includes two reversing units RTA, RTB instead of the reversing unit RT of the substrate processing apparatus 100 according to the first embodiment. As shown in FIG. 11(b), the reversing unit RTA is provided above the substrate platforms PASS1, PASS2, and the reversing unit RTB is provided below the substrate platforms PASS1, PASS2.

(2-2) Details of the Reversing Units

For the reversing units RTA, RTB, different points from the reversing unit RT of FIG. 4 will be described. Note that the reversing units RTA, RTB have the same configuration.

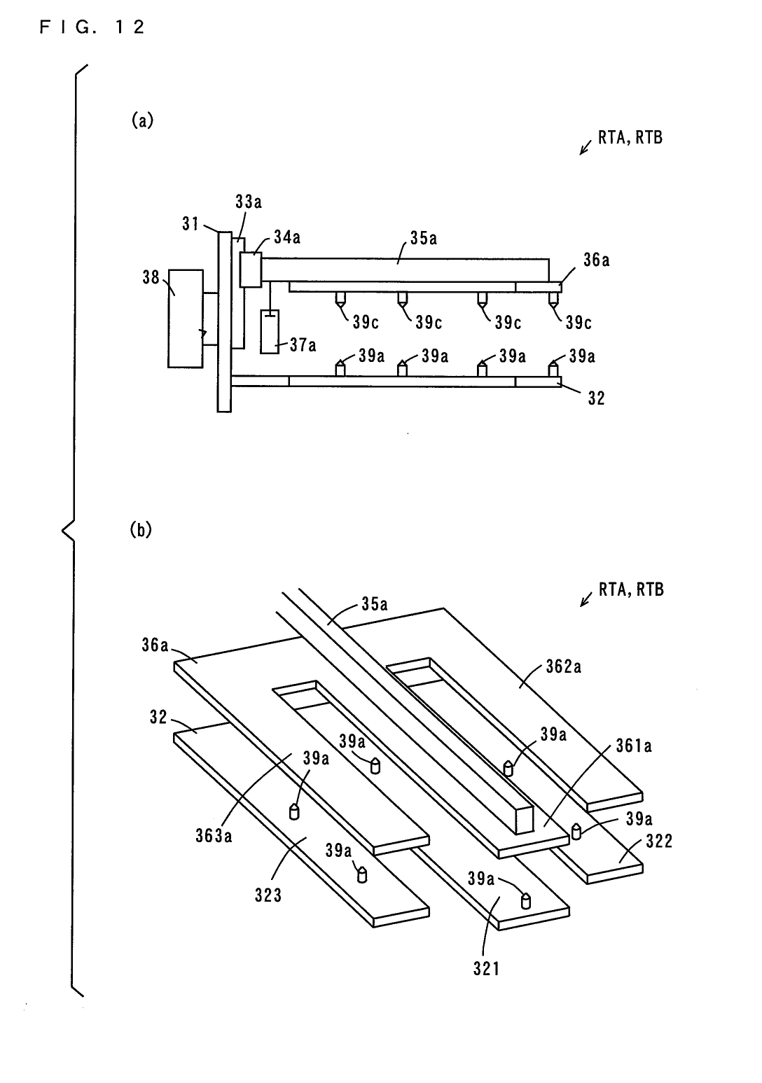

FIG. 12(a) is a side view of the reversing units RTA, RTB, and FIG. 12(b) is a perspective view of the reversing units RTA, RTB. As shown in FIG. 12(a) and FIG. 12(b), each of the reversing units RTA, RTB does not have the second movable plate 36b, and the support pins 39b are not provided on the surface of the fixed plate 32 facing the second movable plate 36b.

In the second embodiment, the substrate W before the back surface cleaning processing is carried into the reversing unit RTA. The substrate W with the top surface thereof directed upward is reversed by the reversing unit RTA, so that the back surface thereof is directed upward. Moreover, the substrate W after the back surface cleaning processing is carried into the reversing unit RTB. The substrate W with the back surface thereof directed upward is reversed by the reversing unit RTB, so that the top surface thereof is directed upward.

(2-3) Effects of the Second Embodiment

In the second embodiment, the substrate W is reversed by the different reversing units RTA, RTB before the back surface cleaning processing and after the back surface cleaning processing, respectively. In this case, even though the back surface of the substrate W before the back surface cleaning processing is contaminated, the contaminants will not be transferred to the substrate W after the back surface cleaning processing. Accordingly, the back surface of the substrate W after the back surface cleaning processing can be kept clean, and therefore processing defects of the substrate W resulting from the contamination of the back surface can be prevented.

Note that two of the reversing unit RT of the first embodiment may be provided instead of the reversing units RTA, RTB, so that one reversing unit RT reverses the substrate W before the back surface cleaning processing, and the other reversing unit RT reverses the substrate W after the back surface cleaning processing.

### (3) Other Embodiments

While the back surface cleaning processing is performed on the substrate W after the top surface cleaning processing in the above described embodiment, the invention is not limited to this and the top surface cleaning processing of the substrate W may be performed after the back surface cleaning processing. In this case, the substrate W is reversed by the reversing unit RT (or the reversing unit RTA) so that the back surface thereof is directed upward before the back surface cleaning processing is performed on the substrate W. After the back surface cleaning processing is performed on the substrate W, the substrate W is subsequently reversed by the reversing unit RT (or the reversing unit RTB) so that the top surface thereof is directed upward. Then, the top surface cleaning processing is performed on the substrate W.

Note that in this case, the main robot MR transports the substrate W by use of the hand MRH2 until the substrate W after the back surface cleaning processing is carried into the reversing unit RT (or the reversing unit RTB). After the substrate W is reversed by the reversing unit RT (or the reversing unit RTB), the main robot MR transports the substrate W by use of the hand MRH1.

Furthermore, while the top surface and the back surface of the substrate W are cleaned by use of the brush in the top surface cleaning unit SS and the back surface cleaning unit SSR in the above described embodiment, the present invention is not limited to this and the top surface and the back surface of the substrate W may be cleaned by use of a chemical liquid.

Moreover, while the indexer robot IR uses the hand IRH2 to hold the unprocessed substrate W and the hand IRH1 to hold the substrate W that has been subjected to the top surface cleaning processing and the back surface cleaning processing in the above described embodiment, conversely, the hand IRH1 may be used to hold the unprocessed substrate W, and the hand IRH2 may be used to hold the substrate W that has been subjected to the top surface cleaning processing and the back surface cleaning processing.

In addition, while the main robot MR uses the hand MRH2 to hold the top surface of the substrate W before the top surface cleaning processing and the back surface of the substrate W before the back surface cleaning processing, and uses the hand MRH1 to hold the top surface of the substrate W after the top surface cleaning processing and the back surface of the substrate W after the back surface cleaning processing, conversely, the hand MRH1 may be used to hold the top surface of the substrate W before the top surface cleaning processing and the back surface of the substrate W before the back surface cleaning processing, and the hand MRH2 may be used to hold the top surface of the substrate W after the top surface cleaning processing and the back surface of the substrate W after the back surface cleaning processing.

Furthermore, while the substrate W before the back surface cleaning processing is held by the support pins 39c on the first movable plate 36a and the support pins 39a on the fixed plate 32, and the substrate W after the back surface cleaning processing is held by the support pins 39d on the second movable plate 36b and the support pins 39b on the fixed plate 32 in the reversing unit RT of the above described first embodiment, the present invention is not limited to this and the substrate W before the back surface cleaning processing may be held by the support pins 39d on the second movable plate 36b and the support pins 39b on the fixed plate 32, and the substrate W after the back surface cleaning processing may be held by the support pins 39c on the first movable plate 36a and the support pins 39a on the fixed plate 32.

Moreover, while the substrate W before the back surface cleaning processing is reversed by the reversing unit RTA and the substrate W after the back surface cleaning processing is reversed by the reversing unit RTB in the above described second embodiment, the present invention is not limited to this and the substrate W before the back surface cleaning processing may be reversed by the reversing unit RTB and the substrate W after the back surface cleaning processing may be reversed by the reversing unit RTA.

In addition, while multi-joint type transport robots that linearly move their hands forward and backward by moving their joints are used as the indexer robot IR and the main robot MR in the above described embodiment, the present invention is not limited to this and linear-type transport robots that move their hands forward or backward by linearly sliding them to the substrate W may be used.

The number of the reversing unit RT, RTA, RTB, the top surface cleaning unit SS and the back surface cleaning unit SSR may suitably be changed depending on their processing speeds.

### (4) Correspondences Between Structural Elements in Claims and Elements in the Embodiments

In the following paragraphs, non-limiting examples of correspondences between various elements recited in the claims below and those described above with respect to various embodiments of the present invention are explained.

In the above described embodiment, the back surface cleaning unit SSR is an example of a first cleaning processing unit, the reversing units RT, RTA, RTB are examples of a reversing device, the main robot MR is an example of a first transport device, the fixed plate 32, the first movable plate 36a, the support pins 39a, 39c and the cylinder 37a are examples of a first holding mechanism, the fixed plate 32, the second movable plate 36b, the support pins 39b, 39d and the cylinder 37b are examples of a second holding mechanism, the rotary actuator 38 is an example of a rotating mechanism, the rotary actuator 38 of the reversing unit RT is an example of a common rotating device, the fixed plate 32 of the reversing unit RT is an example of a common reverse holding member and the support pin 39a of the reversing unit RT is an example of a first supporter.

In addition, the first movable plate 36a of the reversing unit RT is an example of a first reverse holding member, the support pin 39c of the reversing unit RT is an example of a second supporter, the cylinder 37a of the reversing unit RT is an example of a first driving mechanism, the support pin 39b of the reversing unit RT is an example of a third supporter, the second movable plate 36b of the reversing unit RT is an example of a second reverse holding member, the support pin 39d of the reversing unit RT is an example of a fourth supporter and the cylinder 37b is an example of a second driving mechanism.

Moreover, the rotary actuator 38 of the reversing unit RTA is an example of a first rotating device, the rotary actuator 38 of the reversing unit RTB is an example of a second rotating device, the hand MRH2 is an example of a first transport holder, the hand MRH1 is an example of a second transport holder, the carrier C is an example of a storing container, the carrier platform 40 is an example of a container platform, the substrate platform PASS2 is an example of a first interface, the substrate platform PASS1 is an example of a second interface, the indexer robot IR is an example of a second transport device, the hand IRH2 is an example of a third transport holder, the hand IRH1 is an example of a fourth transport holder and the top surface cleaning unit SS is an example of a second cleaning processing unit.

As each of various elements recited in the claims, various other elements having configurations or functions described in the claims can be also used.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A substrate processing apparatus that performs processing on a substrate having a top surface and a back surface, comprising:
a first cleaning processing unit that cleans said back surface of the substrate;
a reversing device that reverses said top surface and said back surface of the substrate; and
a first transport device that transports the substrate between said first cleaning processing unit and said reversing device, wherein
said reversing device includes
a first holding mechanism that holds the substrate,
a second holding mechanism that holds the substrate, and
a rotating mechanism that rotates said first and second holding mechanisms around substantially horizontal axes, respectively, and
said first transport device carries the substrate before cleaning by said first cleaning processing unit into said first holding mechanism of said reversing device, and carries the substrate after the cleaning by said first cleaning processing unit into said second holding mechanism of said reversing device.

2. The substrate processing apparatus according to claim 1, wherein said rotating mechanism includes a common rotating device that integrally rotates said first and second holding mechanisms around the substantially horizontal axis.

3. The substrate processing apparatus according to claim 2, wherein
said first and second holding mechanisms include a common reverse holding member that has one surface and the other surface,
said first holding mechanism includes
a plurality of first supporters that are provided on said one surface of said common reverse holding member and support a periphery of the substrate,
a first reverse holding member that is provided so as to face said one surface of said common reverse holding member,
a plurality of second supporters that are provided on a surface of said first reverse holding member that faces said common reverse holding member and support the periphery of the substrate, and
a first driving mechanism that moves said first reverse holding member relative to said common reverse holding member so that said first reverse holding member is selectively shifted between a first state where said first reverse holding member and said common reverse holding member are spaced apart from each other and a second state where said first reverse holding member and said common reverse holding member are close to each other, and
said second holding mechanism includes
a plurality of third supporters that are provided on said other surface of said common reverse holding member and support the periphery of the substrate,
a second reverse holding member that is provided so as to face said other surface of said common reverse holding member,
a plurality of fourth supporters that are provided on a surface of said second reverse holding member that faces said common reverse holding member and support the periphery of the substrate, and
a second driving mechanism that moves said second reverse holding member relative to said common reverse holding member so that said second reverse holding member is selectively shifted between a third state where said second reverse holding member and said common reverse holding member are spaced apart from each other and a fourth state where said second reverse holding member and said common reverse holding member are close to each other.

4. The substrate processing apparatus according to claim 1, wherein
said rotating mechanism includes
a first rotating device that rotates said first holding mechanism around the substantially horizontal axis, and
a second rotating device that rotates said second holding mechanism around the substantially horizontal axis.

5. The substrate processing apparatus according to claim 1, wherein
said first transport device includes first and second transport holders that hold a lower surface of the substrate,
said first transport holder holds the lower surface of the substrate when the lower surface of the substrate is a back surface before the cleaning by said first cleaning processing unit, and said second transport holder holds the lower surface of the substrate when the lower surface of the substrate is the back surface after the cleaning by said first cleaning processing unit.

6. The substrate processing apparatus according to claim 5, further comprising:
a container platform on which a storing container that stores the substrate is placed,
first and second interfaces for receiving and transferring the substrate,
a second transport device that transports the substrate between the storing container placed on said container platform and said first and second interfaces, wherein
said second transport device includes third and fourth transport holders that hold the substrate, transports the substrate before the cleaning by said first cleaning processing unit from the storing container placed on said container platform to said first interface by said third transport holder, and transports the substrate after the cleaning by said first cleaning processing unit from said second interface to the storing container placed on said container platform by said fourth transport holder, and
said first transport device holds the substrate by said first transport holder in a transport path from said first interface to said first holding mechanism, and holds the substrate by said second transport holder in a transport path from said second holding mechanism to said second interface.

7. The substrate processing apparatus according to claim 1, further comprising a second cleaning processing unit that cleans said top surface of the substrate, wherein
said first transport device transports the substrate among said first cleaning processing unit, said second cleaning processing unit and said reversing device.
